(19) United States
(12) Patent Application Publication
(10) Pub. No.: US 2009/0138302 A1
(43) Pub. Date: May 28, 2009

(54) METHOD AND SYSTEM FOR COLLECTING, RECEIVING, AND TRANSFERRING TRANSACTION INFORMATION FOR USE BY A BONUS OR LOYALTY PROGRAM AND ELECTRONIC VOUCHERS

(76) Inventors: Gregor Breznik, Ljubljawa (SI); Amor Chowdhury, Gornja Radgona (SI)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/946,742

(22) Filed: Nov. 28, 2007

(51) Int. Cl. G06F 17/30; G06Q 20/00

(52) U.S. Cl. 705/7; 705/21; 455/66.1

(57) ABSTRACT

The present invention provides methods and systems for managing mobile virtual network operations. According to some embodiments, purchasing information, e.g., item, price, quantity, location, etc., may be collected using a mobile phone. The collected information may be used as part of a bonus or loyalty program. Collected information might be stored directly on a person's mobile phone. Alternatively, collected information might be stored by using the mobile phone to transfer the collected information to a server or servers. The system for tracking purchasing information may comprise a mobile communication device configured to connect to a transaction center via a mobile telephone network and to collect purchasing information for use by a loyalty program, a payment terminal device connected to a transaction center via a communication link, and a point of sale device, coupled to the payment terminal device and configured to provide items for purchase.

### FIELD OF THE INVENTION

The present invention relates generally to mobile virtual network operations, and more particularly to a method and system for collecting, receiving, and transferring transaction information for use by a bonus or loyalty program and electronic vouchers.

### BACKGROUND OF THE INVENTION

Mobile telephony is booming throughout the world and provides many recently developed applications in data communication. One of the hottest new services is payment through a mobile phone, which is generally referred to as “m-payment”. Several m-payment solutions are currently available, most of which are based on WAP (Wireless Application Protocol) technology that promises to bring all the benefits of the Internet to a mobile phone. Other solutions use calls to a special payment terminal, wherein the calls are activated either from an authorization center or a subscriber or user.

There are severe obstacles preventing faster acceptance of m-payment, especially in a non-internet domain. Such obstacles include the costs of the known payment terminals with regard to their acquisition as well as operating costs. Among other reasons, this is due to the fact that each payment terminal must include a fairly sophisticated communication interface that has to cover all the different, possible new and currently established standards of data communication in mobile telephone networks and phones. In addition, conventional systems require presenting the mobile phone number (or its alias) to the payment terminal, which complicates the payment procedure.

Another drawback of known m-payment systems is that the capabilities are substantially limited to the handling of basic financial transactions, including the exchange of financial transaction data (such as authentication, authorization and payment data) between a point of sale device and a payment or authorization center. Such systems do not provide an integrated solution for the management of a wide variety of services via a mobile virtual network.

### SUMMARY OF THE INVENTION

According to various embodiments methods and systems for managing mobile virtual network operations are provided, including without limitation (i) mobile payment services, (ii) loyalty services, (iii) bonus services, (iv) prepaid airtime distribution services, (v) stored value account management services, (vi) gift certificate distribution services, (vii) bill payment services, and (viii) content delivery services.

According to an embodiment, transaction information, such as purchasing information may be collected using a mobile phone. Additionally, the mobile phone may be used to identify a user to a bonus or loyalty program server. The mobile phone may be a cellular telephone, PCS telephone, or any other mobile communication device. Purchasing information might include the item or items purchased, the price of the item or items, the quantity of each item purchased, the location of the purchase, etc. In some embodiments transaction information such as transaction frequency, purchase frequency, average account value, and other transaction information may be monitored. The collected information may be used as part of a bonus or loyalty program. In this way the bonus or loyalty program may be customized based on a particular person's purchasing habits. In some embodiments items purchased may be used to try to determine or predict what items might be purchased in the future.

In accordance with an embodiment, collected information might be stored directly on a person's mobile phone. For example, when an item is purchased in a store, the person purchasing the item can identify herself using her mobile phone. Various information about the purchase may be stored on the mobile phone, e.g., items purchased, price, quantity, location, etc.

According to a further embodiment, collected information might be stored by using the mobile phone to transfer the collected information to a server or servers, e.g., by using a transceiver in the mobile phone. In some embodiments the collected information might be stored directly on a person's mobile phone, transmitted to the server or servers and then deleted from the memory of the mobile phone. In another embodiment the information might be stored in both locations, for example, as a backup for the data stored on the server. Accordingly, if a server failed a new server could request that information be retransmitted.

Other features of the present invention should become apparent from the following description of the preferred embodiments, taken in conjunction with the accompanying drawings, which illustrate, by way of example, the principles of the invention.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein may illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

Embodiments of the present invention will now be described, by way of example only, with reference to the following drawings, in which:

FIG. 1 is a diagram illustrating the architecture of an exemplary customer loyalty program according to one embodiment.

FIG. 2 is a diagram illustrating an exemplary mobile phone loyalty program according to one embodiment.

FIG. 3 is a diagram illustrating one embodiment in which a customer selects a type of gift certificate, provides delivery details and purchases the gift certificate.

FIG. 4 is a diagram illustrating another embodiment in which the customer purchases a gift certificate at a point of sale using a point of sale terminal and mobile payment system.

FIG. 5 is a diagram illustrating an exemplary embodiment of a shared account system.

FIG. 6 is a diagram illustrating an exemplary embodiment of a bonus and loyalty program wherein a retail company is also a mobile communication provider.

### DETAILED DESCRIPTION OF THE PREFERRED EMBODIMENTS

In the following paragraphs, embodiments of the present invention will be described in detail by way of example with reference to the attached drawings. Throughout this description, the preferred embodiment and examples shown should be considered as exemplars, rather than as limitations on the present invention. As used herein, the “present invention” or “invention” refers to any one of the embodiments of the invention described herein, and any equivalents. Furthermore, reference to various feature(s) of the “present invention” throughout this document does not mean that all claimed embodiments or methods must include the referenced feature(s).

In the payment terminal device, the first interface means comprises a coupling means for coupling the interface means to the mobile phone. Specifically, the coupling means is used to transfer data between the mobile phone and the processing means via the coupling means and the first interface means (or vice versa). The second interface enables the payment device to contact the transaction center by itself, and also to inform the provider of the point of sale device (e.g., when maintenance is required). The number of direct contacts between the mobile telephone and the payment terminal may be minimized in some embodiments.

By way of example, the second interface may comprise a wireless communication modem, a wired communication modem such as a PSTN modem, an ISDN modem, a cable modem, a GSM, or a UMTS modem, for coupling to the related networks in order to provide a second direct connection from the payment terminal device to the transaction center. The second interface means may be capable of converting data transferred between the second interface device and the transaction center into data that may be processed by the processing means and the transaction center (and vice versa).

The first interface helps enabling an authorization process. It is not necessary to transfer the whole authorization data via the first interface, but only a part of it, which simplifies the procedure for the user. It is one of the tasks of the first interface to help the payment terminal to determine the (phone) number, or other identification data of the mobile phone and the number of the payment terminal.

The second interface device can be used for different tasks. One task may be, to simplify the use of the payment terminal. One problem of the system is, that the user (or the mobile phone of the user), the point of sale (point of sale) device in proximity to the mobile telephone of the user, and the amount of the payment transaction have to be identified. The identification of the phone or the user may be done e.g. by an automatic call number transfer as in the case of a caller identification as known e.g. from mobile phone calls, or by a query of the SIM (Subscriber Identification Member) card of the mobile telephone. The identification of the phone of the user may be executed very simply or even automatically.

The identification of the point of sale device can be executed e.g. by transferring an identification code from the terminal device to the transaction center. The identification may be performed by a circle transmission e.g. from the transaction center via the payment terminal and the mobile phone back to the transaction center or vice versa. The circle transmission may also be started from the payment terminal device or from the mobile phone. A circle transmission may also be used to determine the close proximity of the mobile terminal device to the payment terminal device or the point of sale device.

Another task can be to minimize the communication time between the mobile phone and the transaction center. Generally, the shorter the communication time between the mobile telephone device and the payment terminal is, the less errors can occur during transmission, and the shorter the time the customer has to press the mobile phone device to the payment terminal. Additionally, this can lead to less the communication costs for the user are. According to one design of the payment terminal device, the payment terminal device or the transaction center may initiate the connection between the transaction center and the payment terminal device.

In one or more embodiments the data transfer between the mobile phone and the payment terminal device is a one-way data transfer. Standard procedures and terminals utilize only one data connection between the mobile terminal device and the payment terminal. When using these standard procedures the entire communication between a payment terminal device and a transaction center may be observed by the user. According to some embodiments, the authentication of the transfer may be performed via a different transmission channel than the request for the payment. This enables a safer and more reliable payment transaction, as at least one connection between the payment terminal and the transaction center is not observable by a user.

According to an embodiment of the invention, a transaction center (an entity responsible for authentication, authorization and corresponding payment and settlement procedures of the transaction) may comprise a communication interface for coupling the transaction center to a mobile voice network, a subscriber database that stores data relating to each of the users, e.g. at least the telephone number, a corresponding PIN code and the agreed method of payment, e.g. from credit card, from bank-account etc., assigned to each of the users, and optionally a comprehensive CRM, i.e. the complete information on customer's purchases and thus the possibility of personalized services, advertising, etc., and optionally the user's secret code, and a transaction interface that is connected by means of the data communication connection to an other financial information system. A transaction interface may be connected to the communication interface by means of a bi-directional data connection. Further, a subscriber's database may be connected to the transaction interface and to the communication interface by means of a data communication line.

The systems and methods described herein, whether implemented using the voice data transfer technology described above or via any other data transfer technology, may be configured to handle a wide variety of transactions. As described in detail above, financial transactions for goods and services may be handled by this system using a terminal which may be located at the point of sale or at a remote location. Transactions involving credits, points, rewards, frequent flier miles, or any other form of value can also be managed in a similar fashion. Accounts that accrue value of this type are sometimes referred to as loyalty wallets.

According to some embodiments, transaction information, such as purchasing information can be collected using a mobile phone. The mobile phone may be a cellular telephone, PCS telephone, or any other mobile communication device. Purchasing information may include the item or items purchased, the price of the item or items, the quantity of each item purchased, the location of the purchase, etc. In some embodiments transaction information such as transaction frequency, purchase frequency, average account value, and other transaction information may be monitored.

The collected information may be used as part of a bonus or loyalty program. In some embodiments a loyalty program may be a structured marketing effort that rewards and therefore encourages loyal buying behavior because loyal behavior is generally beneficial to the business institution the loyalty program.

Generally, in marketing, retailing, etc., a loyalty card, reward card, points card, club card, etc. may be used to identify a card holder as a member of one or more loyalty programs. The card can be a plastic or paper card similar to a credit card or debit card. Other arrangements are also possible, such as a smaller card that can be attached to a key chain. In some embodiments the systems and methods described herein can be used to replace one or more of these types of cards. For example, in one embodiment a mobile phone may be used in place of a loyalty, reward, or points card.

The bonus or loyalty program may be customized based on a particular person's purchasing habits. For example, by using a mobile virtual network operator (“MVNO”), or other mobile communication service provider to track the particular person's spending habits. In some embodiments items purchased may be used to try to determine or predict what items might purchase in the future.

In accordance with one or more embodiments, collected information may be stored directly on a person's mobile phone. For example, when an item is purchased in a store, the person purchasing the item may identify himself using his mobile phone. Various information about the purchase may be stored on the mobile phone, e.g., items purchased, price, quantity, location, etc.

According to a further embodiment, collected information might be stored by using the mobile phone to transfer the collected information to a server or servers, e.g., by using a transceiver in the mobile phone. In some embodiments the collected information might be stored directly on a person's mobile phone, transmitted to the server or servers and then deleted from the memory of the mobile phone. In another embodiment the information might be stored in both locations, for example, as a backup for the data stored on the server. Accordingly, if a server failed a new server could request that information be retransmitted.

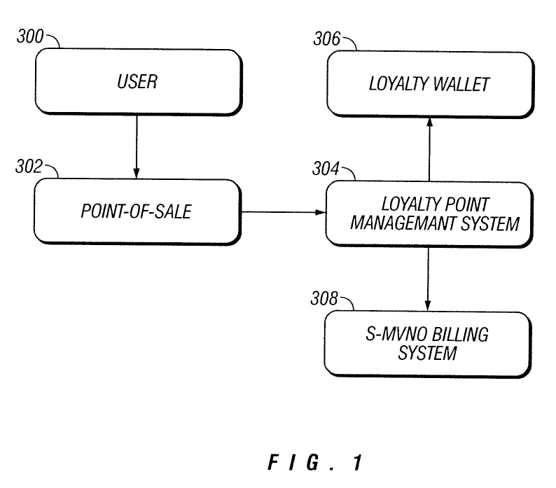

In some embodiments, a mobile voice network is used to manage accounts and handle transactions relating to a customer loyalty program that awards points to loyal customers based on the value of their purchases. Referring to FIG. 1, the architecture of an exemplary customer loyalty program is directed. In this embodiment, the user 300 may pay for goods or services using a mobile phone at the point of sale 302. The user 300 may also use the mobile phone at a point of sale to identify herself, to a loyalty or bonus program. In this way the mobile phone may be used in place of both loyalty cards, bonus cards, points cards, etc. and payment cards, such as credit cards or debit cards.

Alternatively, the user 300 may simply use the mobile phone at a point of sale to identify herself while paying using some other means, such as cash, credit card, etc. In this way the mobile phone may be used in place of a loyalty card, bonus card, points card, etc. The point of sale terminal provides relevant information regarding the transaction to the loyalty point management system 304, which then credits the newly accrued points to the user's loyalty program account, also referred to as a “loyalty wallet” 306. Points can be used for air-time credit, loyalty wallet credit, etc. In some embodiments a loyalty wallet may be credited points that may be used for future purchases. In another embodiment a user 300 may gain air-time credit. Air-time credit may include crediting some number of minutes of mobile communication services to the mobile phone account used to make the credited purchases, crediting some number of text messages to the mobile phone account, etc. In some embodiments the air-time minutes, text messages, or points may be calculated using a formula.

A mobile phone or other mobile communication device may be enabled for use with a loyalty or bonus program using the mobile phone Mobile Subscriber Integrated Services Digital Network (“ISDN”) Number (“MSISDN”), e.g., caller identification (“Caller ID”). In some embodiments a users mobile telephone number might be paired to a user's electronic payment instrument, such as a debit card, credit card, or stored value account. For example, the MSISDN, Caller ID, etc. may be used so that the mobile phone can identify a user to a bonus or loyalty program server.

In another embodiment a purchase may be billed to the user's mobile telephone account. In other words, if a user 300 uses a mobile telephone to purchase fuel at a gas station, that purchase will be reflected on the user's mobile telephone bill along with any mobile telephone calls, text messages, internet browsing, etc. The user 300 may then pay for the gasoline purchase when paying for the mobile telephone bill.

For example, the loyalty point management system 304 may also be linked to a Supported Mobile Virtual Network Operator (“S-MVNO”) billing system 308. In this way, the S-MVNO billing system may be used to bill the user 300 for any purchases. A Mobile Virtual Network Operator (“MVNO”) is generally a company that provides mobile telephone service but does not have all of the infrastructure required to provide mobile telephone service or its own allocation of the radio frequency spectrum. Usually a mobile virtual network operator (“MVNO”) procures bandwidth from an mobile network operator (“MNO”) and has the right to manage it's own subscription plans.

A retail MVNO (“R-MVNO”) is generally operated by a retail operator to leverage on an existing user base, e.g., the existing retail customers. The S-MVNO or S-MNO are supported MVNO or MNOs. In other words, these MVNO/MNOs support loyalty or gift programs, e.g., one or more of the systems and methods described herein.

In an alternative embodiment, the user 300 may designate various alternative accounts for the deposit or use of the newly accrued points. For example, the loyalty point management system may credit the newly accrued points to a variety of different user accounts, or convert the value of the points into an alternative reward such as mobile phone air-time or data transmission credits, frequent flier miles, gift card credits, etc. based on a pre-defined formula.

In some embodiments of such a user loyalty program, users 300 pre-register for the loyalty program and select how accrued points are to be applied. The loyalty point management system may be configured to require pre-selected application of accrued points, such as conversion to mobile phone air-time, or they may provide for user-directed application at the time of accrual or even at a future date. The mobile voice network may also be used to manage redemption of points in any form. For example, the systems and methods described herein may be used to redeem loyalty points, gift card credit, or any other form of value accrued under the program directly at the point of sale.

The accrual and conversion of loyalty points, credits or any other form of value may be based on a variety of consumer conduct. For example, the value of accrued loyalty points may be fixed directly to the value of goods or services purchased (i.e. $100 in purchases accrues 50 points), linked to the purchase of particular goods or services (i.e. the purchase of a particular brand or model of television accrues 500 points), or determined using any other formula. The value of accrued loyalty points may also be modified or adjusted to promote sales of particular goods or services. Additionally, these accrued loyalty points might be stored on the user's mobile phone.

The timing of conversions can also be controlled depending on the account and type of credit that is applied. For example, conversion of loyalty points to air-time for pre-paid mobile phone subscribers may occur in virtual real-time, while conversion for post-paid subscribers may be deferred to the end of a billing cycle and credited against the balance due.

In some embodiments user can check or be informed about his bonus or loyalty points, rewards, promotions, discounts, special programs, etc. For example, the user might receive text message updates, voice mail updates, or might be able to request updates for his bonus or loyalty points. The user may also request updates about past, current, or future rewards, promotions, discounts, special programs, etc. in other words, in some embodiments a user may request reward program and/or updates, in other embodiments these updates might be transmitted automatically. Alternatively, some embodiments might use a combination of the two.

As discussed above, many different methods might be used to transmit this information to a user, for example, text messages, e.g., SMS; voice mail messages; GPRS, FRID, voice call, IVR, DTMF, web/wap access, etc. Almost any mobile phone based communication format currently known or developed in the future may by used to implement the systems and methods described herein.

A user of the systems and methods described herein may, in some embodiments, collect bonus points, collect loyalty points, for example, by using her mobile phone. Additional, the user might receive rewards, discounts, etc., for example using her phone.

Many different types and kinds of providers may benefit from the systems and methods described herein. For example, merchants, which may be any retail or wholesale entity providing or selling products, services, etc. The products or services may be sold at a point of sale, for example, a physical retail point of sale, an internet point of sale, e.g., a web sites, etc. Sales might occur from catalogs, door-to-door, or almost any other way sales occur. These sales can be tracked, paid for, and rewards might be given for these sales using theses systems and methods. In some embodiments, service providers may include financial institutions, banks, credit card, companies, private label card companies, airlines, airlines, e.g., with frequent flyer programs, and just about any type of service that might use some types of reward or loyalty program.

In one embodiment a restaurant might use a bonus or loyalty program. For example, a waiter might ask a patron if she belongs to the restaurant's bonus and loyalty program, or perhaps a “universal” bonus or loyalty program, e.g., a bonus or loyalty program that allows a user to dine at multiple restaurants and accrue bonus or loyalty points. The customer may then identify herself using a mobile telephone. If any rewards, bonus, discounts, etc. have been accrued, the waiter may give these to the customer. For example, a reward might be one or more of the following: a free meal, a discount off of the bill, a free drink, etc. The provider of the bonus or loyalty program may communicate that the user is a member of the program using the mobile phone. This might be using MMS, text message, etc., as discussed above. The message might be sent to the customer's mobile phone for viewing, to the waiter's mobile phone, or to any mobile phone or other device that might be generally accessible to, for example, the staff at the restaurant.

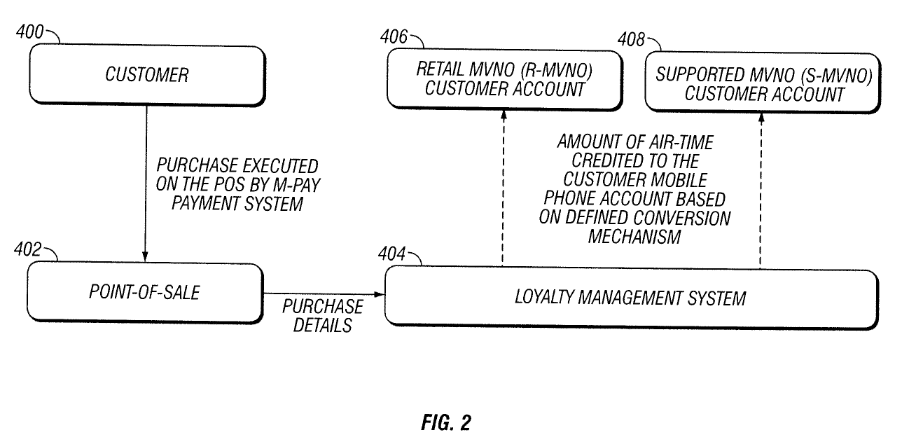

Referring to FIG. 2, an embodiment of an exemplary mobile phone loyalty program is disclosed. In this embodiment, the customer 400 executes a purchase at a participating retail point of sale 402 using a mobile payment system. Details of the transaction are transmitted from the point of sale terminal to the loyalty program management system 404. The loyalty program applies the appropriate credit to the customer's loyalty account. When the customer's 400 mobile phone account bill comes due, accrued credit in the loyalty account is converted to air-time credit or other value and applied against the customer's mobile phone account bill.

In another embodiment of a mobile phone loyalty program, the customer prepays money into a retail customer loyalty account or electronic wallet to be applied to future retail purchases. For example, a retail Mobile Virtual Network Operator (“R-MVNO”) customer account 406 may be credited for future retail purchases. In another embodiment loyalty credits based on these future purchases may be credited in advance to the customer's mobile phone account in the appropriate form, such as an air-time credit or “minute bucket.” In some embodiments S-MVNO customer accounts 408 may be linked the loyalty management system 404. These S-MVNO accounts 408 can be MVNO accounts that support one or more loyalty programs, gift programs, or both types of programs.

In another embodiment, loyalty points could be flexibly applied to a variety of different goods and services. In some embodiments any mobile subscription fee for the mobile telephone account might be partially or entirely waived if a customer might prepay a defined amount into an account or “e-wallet” for future retail purchases. In another embodiment points may be flexibly divided or rationed between air-time credit, loyalty “e-wallet”, etc. The rationing may be decided by a customer with each purchase or by a customer selected predetermined percentage.

Similar account management systems may be used to manage the purchase, handling, and redemption of gift certificates or gift cards. In such a system, the mobile voice network is used to issue, deliver, store, and manage the gift certificates or gift cards, and allows for direct redemption at the point of sale.

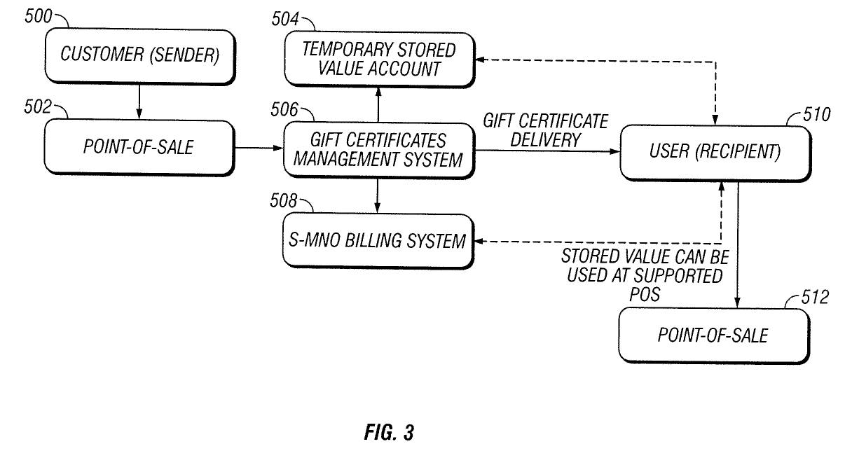

Referring to FIG. 3, in some embodiments the customer 500 selects a type of gift certificate, provides delivery details and purchases the gift certificate. For example, in some embodiments the customer 500 may select cash credited on the user's virtual account. In other embodiments prepaid air-time, e.g., for S-MVNO may be selected. In certain other embodiments products might be selected, e.g., a virtual gift certificate for a specific product, a specific store, or both. As will be understood by a person of skill in the art some combination of cash credits, virtual gift certificates, and products may be selected. The distribution of these items might be user selectable or may be selectable by the service provider.

In some embodiments gift certificate delivery may be determined by entering the recipient's 510 mobile telephone number. In some embodiments this number is verified, for example, by requiring the sender 500 to enter the number twice, compete a telephone call to the recipient 510, or by any other method of determining that the correct recipient 510 has been selected. Delivery might be by MMS, e.g., branding, pictures, music, etc.; SMS, e.g., plain text; WAP, branding, pictures, etc.; or by another mobile electronic communication system or systems.

In some embodiments the sender 500 may select the delivery time and date. For example, the sender 500 might want a birthday gift for recipient 510. The sender might want this gift delivered on the recipient's birthday, or no later than the birthday, etc. The gift certificate may then be delivered using the manner selected by the sender 500. Additionally, after delivery a notification may be sent to sender 500. Further, in some embodiments gift certificates may have an expiration date. The recipient may be electronically reminded of this date on his mobile telephone.

Payment may be made in any form at the point of sale 502, including by use of a mobile phone payment system. The transaction details are then transmitted from the point of sale terminal to the gift certificate management system 506. The gift certificate management system 506 may then stores the value in a temporary account 504 associated with the recipient 510. The value stored in that temporary account 504 may then applied by the recipient using recipient's mobile phone at a point of sale terminal 512 or may be credited to the user's mobile phone account for air-time or other value.

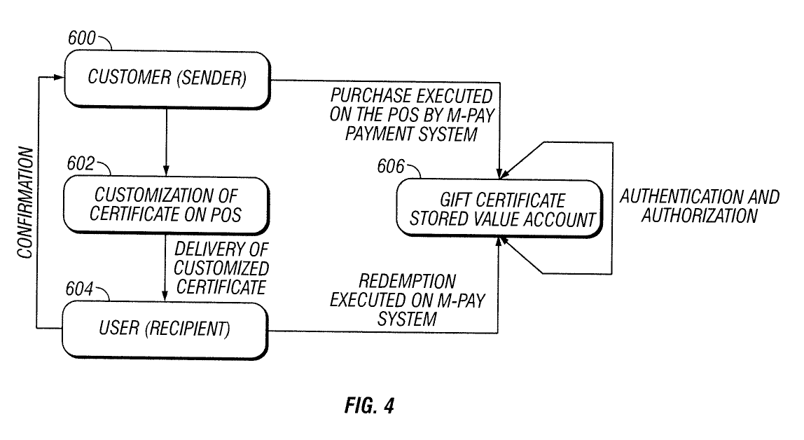

Referring to FIG. 4, in another embodiment the customer 600 purchases a gift certificate at a point of sale using a point of sale terminal and mobile payment system. In some embodiments a mobile telephone may be used to issue and deliver the gift certificate. For example, the sender's mobile telephone may be used in conjunction with a point of sale terminal.

The value of the gift certificate may be stored in a temporary stored value account 606. The gift certificate can be customized 602 by the customer 600 and the delivery method selected. For example, in some embodiments, customization may be input on a point of sale terminal. Upon delivery to the recipient 604, confirmation of delivery may be provided to the customer 600. The recipient 604 may redeem the gift certificate using the mobile payment system and authentication information provided with the gift certificate. For example, the recipient 604 may redeem the gift certificate at a point of sale.

The systems and methods described herein may also be configured to provide for shared accounts for use by businesses or families. For example, the owner of a bank account registered with the mobile payment system may authorize other users to make purchases from the registered account up to a particular value. In such a system, parents or other relatives could register each child and authorize payments up to a certain amount. This virtual allowance would simplify distribution of the value to the other users, avoiding the difficulties and risks associated with handling cash payments. Authorizations could be structured in any way, including single purchase amount limits, time-based amount limits, transaction-based limits, etc.

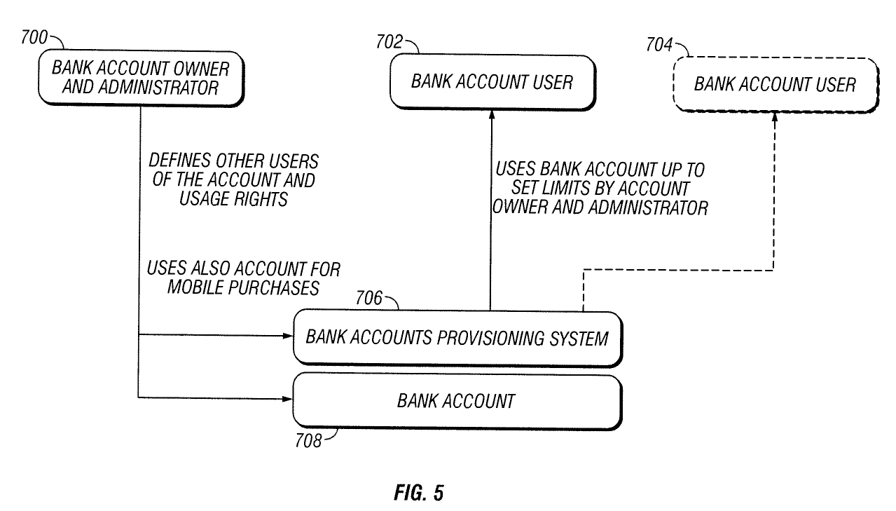

Referring to FIG. 5, an exemplary embodiment of a shared account system is disclosed. The bank account owner or administrator 700 defines the users 702 and 704 who may be authorized to access the account 708 and establishes the scope of their access rights. In some embodiments the owner 700 may register a bank account or accounts and give rights to users 702 and 704 to make purchases up to certain amounts over a period of time. For example, parents might assign certain amounts to their children for spending. In this way problems related to carrying cash, e.g., loss, theft, etc., might be minimized.

In some embodiments transactions can be provisioned based on a single purchase amount limit, a limit over a period of time, e.g., a day, week, month, etc. In some embodiments of the bank account provisioning system 706 the amount may reset at the end of each time period. In other embodiments the amount may accrue over time, e.g., any amount unused in one month may be added to the amount available during the next month. The various authorized users 702 and 704 may access the account 708 using the mobile payment system, for example. Thus multiple users may utilize the same account. First level authorization, e.g., authorization for the owner or administrator, and authorizations for other bank account users may be managed by the systems and methods described herein. Additionally, customer mobile accounts may be linked to many different types of accounts, such as debit, credit, savings, checking, escrow accounts, etc. Further, in some embodiments multiple accounts may be accessed.

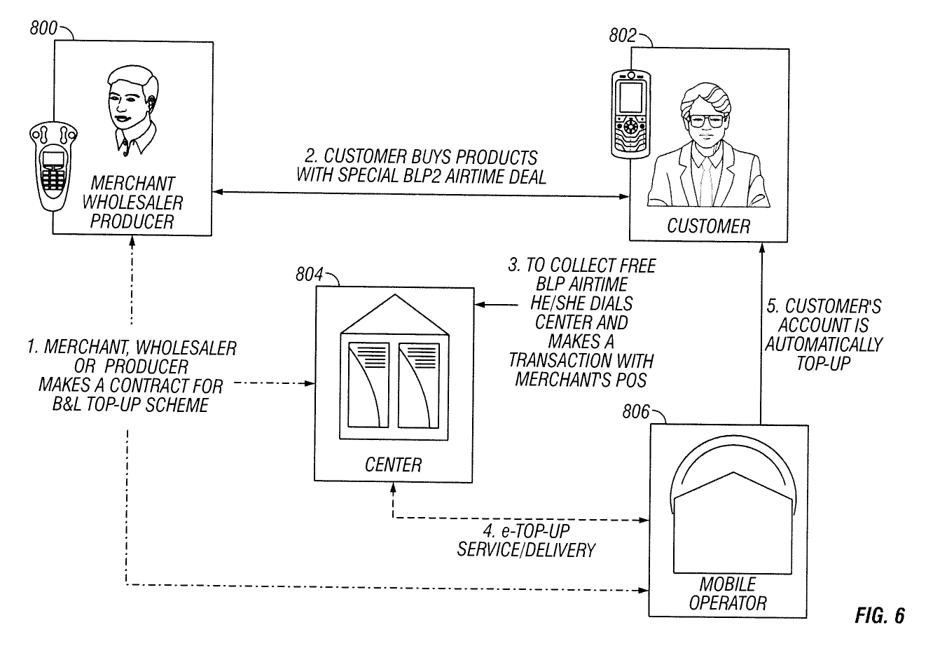

Referring to FIG. 6, an exemplary embodiment of a retail company as a mobile communications provider, e.g., MVNO that has a bonus program, loyalty program, or both. The company 800 may be a merchant, wholesaler, producer, or any other provider of goods and services. Additionally, the term “company” is not intended to be limiting. In some embodiments the company 800 might be any organization, including, e.g., corporations, partnerships, and individuals involved in providing various goods and services that might be sold using the systems and methods described herein.

For example, the company might be a food retail company that also offers mobile communications services as an MVNO. (Generally such a company would offer such services without operating its own mobile network infrastructure, accordingly, the company 800 is probably an MVNO. It will be understood, however, that the systems and methods described herein might, in some embodiments, be applied to mobile telecommunications companies that operate mobile network infrastructure.

A customer 802 might purchase , e.g., groceries at the food retail store. The purchases may be part of a bonus or loyalty program deal. Accordingly, the customer 802 may be rewarded based on the value spent, the particular items purchased, etc. The reward may be free communication services, e.g., airtime, a predetermined number of text messages, etc. For example, a food retailer might offer $10 of free airtime when a customer 802 purchases $20 worth of food at the retailer's store. This airtime may be credited directly to the customer's mobile communication account.

To collect free bonus or loyalty program airtime the customer may dial a center 804 and complete a transaction with a point of sale. For example, in some embodiments the customer 802 may dial an access telephone number, e.g., a number for the center 804. A terminal, e.g., at the point of sale, may be used to exchange information with the transaction center 804 using the mobile telephone connection made by placing the call to the access number. Using the mobile telephone call and the terminal the cost may then be charged to the customer's account, e.g., the mobile phone account, or some other account linked to the mobile phone payment system such as a credit card, debit card, checking account, savings account, etc. The center 804 may then transmit information to a mobile operator 806. For example, information regarding the customer's airtime, such as top up airtime gained as a result of the purchase. (Top up airtime is discussed further below.) In one or more embodiments the company (merchant, wholesaler, producer, etc.) may enter into a contract with the center 804, mobile operator 806, or other entity such that the bonus or loyalty program may be implemented.

In some embodiments, by purchasing, e.g., yogurt, the food retailer will provide the purchaser with some number of mobile communications minutes, text messages, etc. The bonus or loyalty program could be part of a product promotion. Alternatively, products that are nearing expiration or overstocked might also be used in the bonus or loyalty program, e.g., to attempt to sell as much of the product as possible before it expires. The bonus or loyalty program may also be directed towards communication purchases. For example, a customer that purchases and/or uses a certain amount of airtime might be given some kind of bonus, e.g., discounts, free products, etc. that may be purchased at the retailer's store.

As discussed above, in some embodiments a retailer might offer free airtime. In other embodiments a retailer might offer free subscriptions, e.g., any monthly access fee for the mobile telephone network may be waived. The free airtime or free subscriptions may be provided if, for example, the customer 802 purchases a particular product. Similar to above, the free subscription or air time may be based on the purchase of specific products, the purchase of a specific dollar amount, the purchase, and/or use of a certain amount of airtime, etc.

In some embodiments, the company 800 might sell products using vending machines. Accordingly, bonus programs, loyalty programs, or both, may be applied to vending machine purchases. For example, if a customer buys 10 sodas from a company's vending machine the customer might get the next soda free, Other potential offers might include: buy 10 sodas and get a free bag of chips, 10% discount for repeat customers, etc.

In some embodiments the customer 802 may dial an access telephone number. For example, a customer may dial an access number when he or she is near a vending machine, e.g., when the customer 802 would like to make a purchase from the vending machine. A payment terminal, e.g., located on, in, or near the vending machine may be used to exchange information with a transaction center using the mobile telephone connection made by placing the call to the access number.

Using the mobile telephone call and the terminal the cost may then be charged to the customer's account, e.g., the mobile phone account, or some other account linked to the mobile phone payment system such as a credit card, debit card, checking account, savings account, etc. In some embodiments the payment terminal, or other terminal located on, in, or near the vending machine might also be used to communicate vending machine information such as current inventory, incoming cash flow, etc.

In some embodiments payment terminals, located in stores, on vending machines, or any other locations, may also be used to pay for pre-pay mobile telephone service. (These ongoing payments for pre-pay mobile telephone serves are commonly referred to as “topping up”). Similar to the vending machine example, when topping up, the customer 802 may dial an access telephone number and top up using a payment terminal to exchange information with a transaction center using the mobile telephone connection made by placing the call to the access number. The cost may then be paid using, e.g., a credit card, debit card, checking account, savings account, cash, etc.

In some embodiments offers might be made to potential customers in advance. For example, pre-issued discount vouchers may be transmitted to a mobile phone in the form of SMS or MMS bar code, voice token, etc. These offers may be stored on the mobile phone or on a server and can be presented to a retailer, merchant, etc. using an appropriate device based on the type of message transmitted, for example, a bar code reader for bar codes or a voice token recognizer if a voice token is transmitted.

Thus, it is seen that a method and system for collecting, receiving, and transferring transaction information for use by a bonus or loyalty program and electronic vouchers is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

What is claimed is:

1. A system for tracking transaction information comprising:
a mobile communication device that identifies users for use by a loyalty program;
wherein the mobile communication device collects transaction information for use by the loyalty program;
wherein the device is connected to a transaction center via a mobile telephone network;
wherein the device is connected to a payment terminal device, which is connected to a transaction center via a communication link; and
wherein the device is connected to a point of sale device, which is coupled to the payment terminal device to provide for the completion of transactions.

2. The system of claim 1, wherein the transaction information is stored directly on the mobile communication device.

3. The system of claim 1, wherein the transaction information is transmitted to a server for storage and wherein the server is part of the transaction center.

4. The system of claim 1, wherein the transaction information comprises item purchased, price of the item, quantity of the item, and location of the transaction and wherein the system transmits a bonus to the mobile communication device based on the transaction information.

5. The system of claim 4, wherein the bonus provided comprises a discount or a gift voucher and wherein the discount or gift voucher is transferred to another person's mobile communication device.

6. The system of claim 4, wherein the bonus is redeemed using the mobile communication device and wherein the bonus comprises communications airtime.

7. The system of claim 1, wherein the mobile communication device allows access to a shared bank account and wherein the mobile communication device identifies a user to the system.

8. The system of claim 1, wherein the mobile telephone network is accessed through a mobile virtual network operator.

9. The system of claim 8, wherein the mobile virtual network operator comprises a retailer.

10. The system of claim 8, wherein the mobile virtual network operator further comprises a billing system.

11. A mobile communication device comprising:
a transceiver to transmit and receive radio frequency transmissions;
a processor coupled to the transceiver;
a memory coupled to the processor; wherein the memory is capable of storing instructions that cause the mobile communication device to connect to a transaction center via a mobile telephone network and to collect transaction information for use by a loyalty program.

12. The mobile communication device of claim 11, wherein the transaction information is stored directly on the device.

13. The mobile communication device of claim 11, wherein the transaction information is transmitted to a server for storage.

14. The mobile communication device of claim 13, wherein the server is part of a transaction center.

15. The mobile communication device of claim 13, wherein the transaction information is stored directly on the device and transmitted to the server for storage.

16. The mobile communication device of claim 13, wherein the device is configured to identify a user to the transaction center.

17. A method for tracking transaction information comprising:
collecting transaction information for use by a loyalty program using a mobile communication device;
connecting the device to a transaction center via a mobile telephone network;
connecting the device to a payment terminal device which is connected to the transaction center via a communication link; and
connecting the device to a point of sale device, which is coupled to the payment terminal device to provide for the completion of transactions.

18. The method of claim 17, wherein the mobile telephone network is accessed through a mobile virtual network operator.

19. The method of claim 18, wherein the mobile virtual network operator comprises a retailer.

20. The method of claim 18, wherein the mobile virtual network operator further comprises a billing system.

21. A method of using a mobile communication device comprising:
providing a transceiver to transmit and receive radio frequency transmissions;
providing a processor coupled to the transceiver; and
providing a memory coupled to the processor; wherein the memory is capable of storing instructions that cause the mobile communication device to connect to a transaction center via a mobile telephone network and to collect transaction information for use by a loyalty program.

22. The method of claim 21, further comprising storing the transaction information directly on the device.

23. The method of claim 21, further comprising transmitting the transaction information to a server for storage and wherein the server is part of a transaction center.

24. The method of claim 23, further comprising storing the transaction information directly on the device and transmitted to the server for storage.

25. The method of claim 23, further comprising identifying a user to the transaction center using the mobile communication device.
